(19) United States
(12) Patent Application Publication
(10) Pub. No.: US 2011/0004400 A1
(43) Pub. Date: Jan. 6, 2011

(54) APPARATUS AND METHOD FOR PROVIDING ROAD DATA IN MOBILE COMMUNICATION SYSTEM

(75) Inventors: Mun-Seok KIM, Suwon-si (KR); Jeong-Seok SEO, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/820,624

(22) Filed: Jun. 22, 2010

(30) Foreign Application Priority Data
Jul. 1, 2009 (KR) 10-2009-0059656

(51) Int. Cl. G01C 21/36; G01S 19/42

(52) U.S. Cl. 701/201; 701/200

(57) ABSTRACT

An apparatus and a method for providing road data in mobile communication system are provided. The apparatus includes a controller for receiving location information from a terminal having no map data, for mapping a location of the terminal to a map, for generating guide information for the location of the terminal, and for transmitting the guide information to the terminal.

### PRIORITY

This application claims the benefit under 35 U.S.C. §119(a) of a Korean patent application filed in the Korean Intellectual Property Office on Jul. 1, 2009, and assigned Serial No. 10-2009-0059656, the entire disclosure of which is hereby incorporated by reference.

### BACKGROUND OF THE INVENTION

1. Field of the Invention

The present invention relates to an apparatus and a method for confirming a current location of a portable terminal. More particularly, the present invention relates to an apparatus and a method for a portable terminal having no map data to provide a navigation function by obtaining guide information of a current location from another portable terminal having map data.

2. Description of the Related Art

Recently, with increased advances of portable terminals, mobile phones allowing wireless voice call and information exchange are a few necessities. Previously, the portable terminals simply feature portability and wireless communication. As technologies of the portable terminal have developed and wireless Internet has been introduced, the portable terminals are used for not only simple telephone calls or schedule management, but also image capturing using an embedded digital camera, satellite broadcasting view, games, remote control using short-range communication, user location tracking, and the like.

Some portable terminals provide a navigation function which offers traffic information or information of a particular route by accessing a traffic information center.

The navigation function serviced by the portable terminal receives a satellite signal while storing map data, calculates a current location of the mobile, and marks the current location in pre-stored map data. To service the navigation function, disadvantageously, the portable terminal requires equipment for receiving the satellite signal and needs to store the map data.

Recently, a number of terminals capable of receiving the satellite signal have been available. However, to access the satellite signal, map data has to be purchased separately, which increases costs. Thus, the navigation function may be rarely utilized.

For this reason, the navigation function supported by the portable terminal cannot be fully utilized.

Therefore, a need exists for an apparatus and method for providing a navigation function in a portable terminal that does not have separate map data.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for providing a navigation function to a portable terminal that does not support the navigation function in a mobile communication system.

Another aspect of the present invention is to provide an apparatus and a method for providing a navigation function even when a portable terminal does not have separate map data.

In accordance with an aspect of the present invention, an apparatus for providing road data to a terminal having no map data in a portable terminal is provided. The apparatus includes a controller for receiving location information from the terminal having no map data, for mapping a location of the terminal to a map, for generating guide information for the location of the terminal, and for transmitting the guide information to the terminal.

In accordance with another aspect of the present invention, a method for providing road data to a terminal having no map data in portable terminal is provided. The method includes receiving location information from the terminal having no map data, mapping a location of the terminal to a map using the received location information, and generating and transmitting guide information for the location of the terminal to the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram for providing a navigation function according to an exemplary embodiment of the present invention;

FIG. 2 is a diagram for providing a navigation function in a mobile communication system according to an exemplary embodiment of the present invention;

FIG. 3 is a flowchart for providing a navigation function in a portable terminal according to an exemplary embodiment of the present invention; and

FIG. 4 is a flowchart for providing a navigation function in a portable terminal according to an exemplary embodiment of the present invention.

Throughout the drawings, like reference numerals will be understood to refer to like parts, components and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and a method of a mobile communication system for providing a navigation function to a portable terminal having no map data.

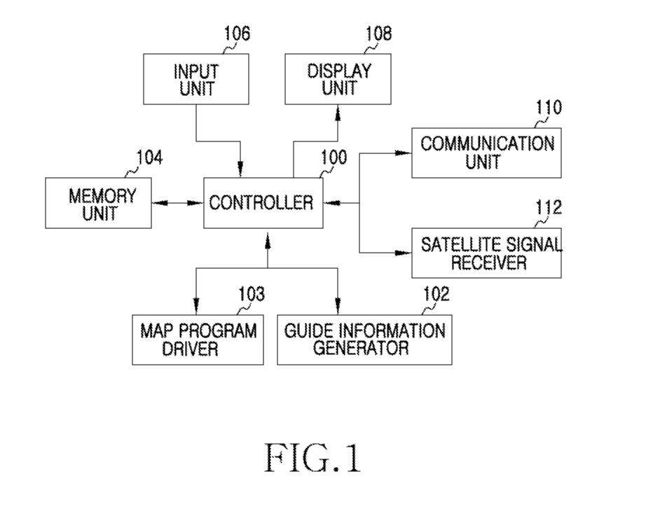

FIG. 1 is a block diagram of a portable terminal providing a navigation function according to an exemplary embodiment of the present invention.

Referring to FIG. 1, the portable terminal includes a controller 100, a guide information generator 102, a map program driver 103, a memory unit 104, an input unit 106, a display unit 108, a communication unit 110, and a satellite signal receiver 112.

The controller 100 of the portable terminal controls functions of the portable terminal. For example, the controller 100 processes and controls voice communication and data communication, determines a location of the portable terminal by receiving a satellite signal in a navigation service, and provides map data of the determined location. In addition, based on the functions of the controller 100, a portable terminal for requesting the navigation function and a portable terminal for providing the navigation function may be distinguished. Herein, the portable terminal for requesting the navigation function may determine a current location of the terminal by receiving the satellite signal but has no map data. The portable terminal for providing the navigation function may determine the current location of the terminal by receiving the satellite signal and has the map data.

The controller 100 of the portable terminal for requesting the navigation function computes the current location of the terminal using the satellite signal received via the satellite signal receiver 112 and provides the computed location information to the portable terminal for providing the navigation function.

The controller 100 receives guide information from the portable terminal for providing the navigation function and transmits the received guide information to a user. That is, the controller 100 of the portable terminal for requesting the navigation function, which has no map data, may use the guide information of the map data received from the portable terminal having the map data, as its map data.

Meanwhile, upon receiving location information from the portable terminal requesting the navigation function, the controller 100 of the portable terminal for providing the navigation function controls the map program driver 103 to drive a map program and to map the location of the terminal requesting the navigation function to a pre-stored map.

The controller 100 controls the guide information generator 102 to generate guide information for the terminal requesting the navigation function, and then transmits the generated guide information to the terminal requesting the navigation function.

The memory unit 104 includes, for example, a Read Only Memory (ROM), a Random Access Memory (RAM), a flash ROM, and the like. The ROM stores microcodes (i.e., code) and various reference data of programs for processing and controlling the controller 100, the guide information generator 102, and the map program driver 103.

The RAM, which is a working memory of the controller 100, stores temporary data generating in a program execution. The flash ROM stores updatable data such as a phone book, outgoing messages, incoming messages, and a touch input point of the user. In an exemplary implementation, the flash ROM stores the location information of the terminal requesting the navigation function and the guide information of the terminal providing the navigation function.

The input unit 106 includes a plurality of function keys such as number key buttons 0˜9, a menu button, a cancel button, an OK button, a call button, an end button, an Internet access button, navigation key buttons, character input keys, and the like. The input unit 106 provides key input data corresponding to a key pressed by the user to the controller 100.

The display unit 108 displays status information, a limited number of characters, videos, and still images generating in an operation of the portable terminal. The display unit 108 may employ a color Liquid Crystal Display (LCD), an Active Mode Organic Light Emitting Diode (AMOLED), and the like. When the display unit 108, which includes a touch input device, is applied to a touch-type portable terminal, it may be used as an input device.

The communication unit 110 processes transmission and reception of radio signals of data input and data output via an antenna (not illustrated). For example, during the transmission of the radio signals, the communication unit 110 channel-codes, spreads, Radio Frequency (RF) processes, and transmits data to transmit. During the reception of the radio signals, the communication unit 110 converts a received RF signal to a baseband signal and restores data by de-spreading and channel-decoding the baseband signal. The communication unit 110 transmits and receives the location information to request the navigation function and the guide information to provide the navigation function.

The satellite signal receiver 112 receives the satellite signal for locating the portable terminal.

Although the controller 100 of the portable terminal may function as the guide information generator 102 and the map program driver 103, the controller 100 and the guide information generator 102 are separately illustrated as an example for convenience of understanding and it should be understood that the present invention is not limited thereto. For example, the controller 100 may process all of the functions of the guide information generator 102 and the map program driver 103.

An exemplary apparatus of a mobile communication system for providing a navigation function to a portable terminal which does not support the navigation function has been described above. An exemplary method for providing the navigation function using the apparatus when the portable terminal has no separate map data according to an exemplary embodiment of the present invention will be described below.

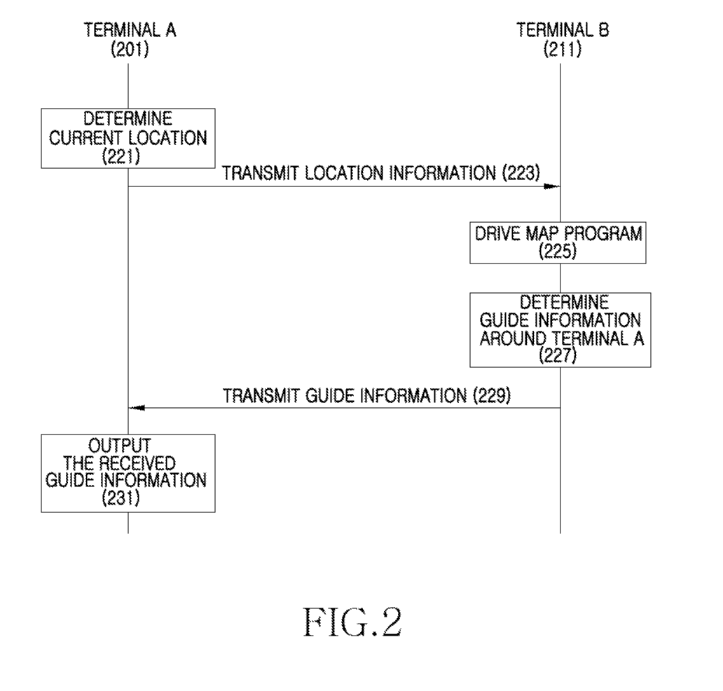

FIG. 2 is a diagram of for providing a navigation function in a mobile communication system according to an exemplary embodiment of the present invention.

Referring to FIG. 2, the mobile communication system may include a terminal A 201 and a terminal B 211. Terminal A 201 may determine its current location by receiving a satellite signal but has no map data. Terminal B 211 may determine its current location by receiving the satellite signal and has the map data.

Terminal A 201 drives a satellite signal reception module, determines its current location in step 221 by receiving necessary information for the location determination, and transmits information of its current location determined to terminal B 211 in step 223. Since terminal A 201 has no map data, the transmission requests guide information based on the current location to terminal B 211. When terminal A 201 is far away from terminal B 211, terminal A 201 and terminal B 211 may be connected using a wireless Internet network. When terminal A 201 is close to terminal B 211, terminal A may transmit the location information using an ad-hoc connection of Wireless Local Area Network (WLAN). Herein, when terminal A 201 and terminal B 211 proceed to the same destination, information relating to a real-time route of terminal A 201 to the destination may be the guide information. When terminal A 201 and terminal B 211 proceed to different destinations, the guide information for terminal A 201 may be information relating to a dangerous zone (e.g., crossroad). Hence, while transmitting the current location information to terminal B 211, terminal A 201 may also transmit information relating to the destination together with the current location information.

Terminal B 211 receiving the location information from terminal A 201 drives a map program in step 255 and determines guide information around terminal A 201 in step 227.

Terminal B 211 transmits the determined guide information around terminal A 201 to terminal A 201 in step 229. Terminal A 201, upon receiving the guide information, outputs the received guide information to the user in step 231. Thus, terminal A 201 may provide the navigation function using the map data of terminal B as its map while storing no map data.

When terminal B 211 is far away from terminal A 201, terminal A 201 and terminal B 211 may be connected using the wireless Internet network. When terminal B 211 is close to terminal A 201, terminal B 211 may transmit the guide information using the ad-hoc connection of the WLAN.

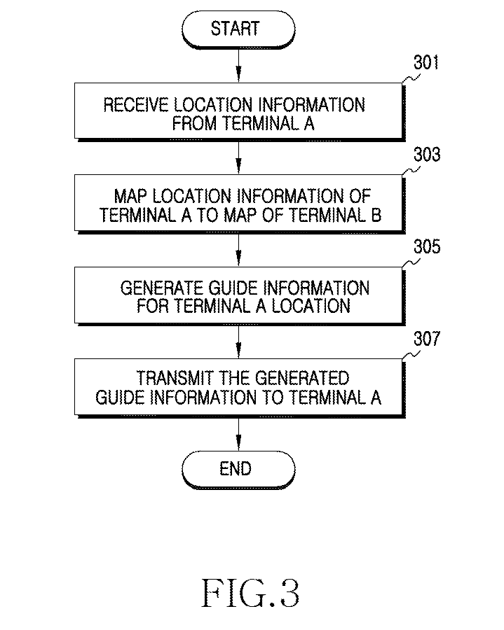

FIG. 3 is a flowchart for providing a navigation function in a portable terminal according to an exemplary embodiment of the present invention.

Referring to FIG. 3, in step 301, the portable terminal receives location information from terminal A. Herein, the portable terminal represents a terminal capable of determining its current location by receiving a satellite signal and having map data. Terminal A represents a terminal capable of determining its current location by receiving the satellite signal but having no map data.

In step 303, the portable terminal drives its map program and then processes to map the location information received from terminal A to the map data, to determine the current location and the movement of terminal A and to determine the guide information based on the location of terminal A.

The portable terminal generates guide information for terminal A location in step 305 and processes to transmit the guide information to terminal A in step 307. Herein, the guide information may use the information relating to the dangerous zone (e.g., crossroad) around terminal A or the information relating to the route of terminal A to the destination as aforementioned.

The portable terminal ends the process.

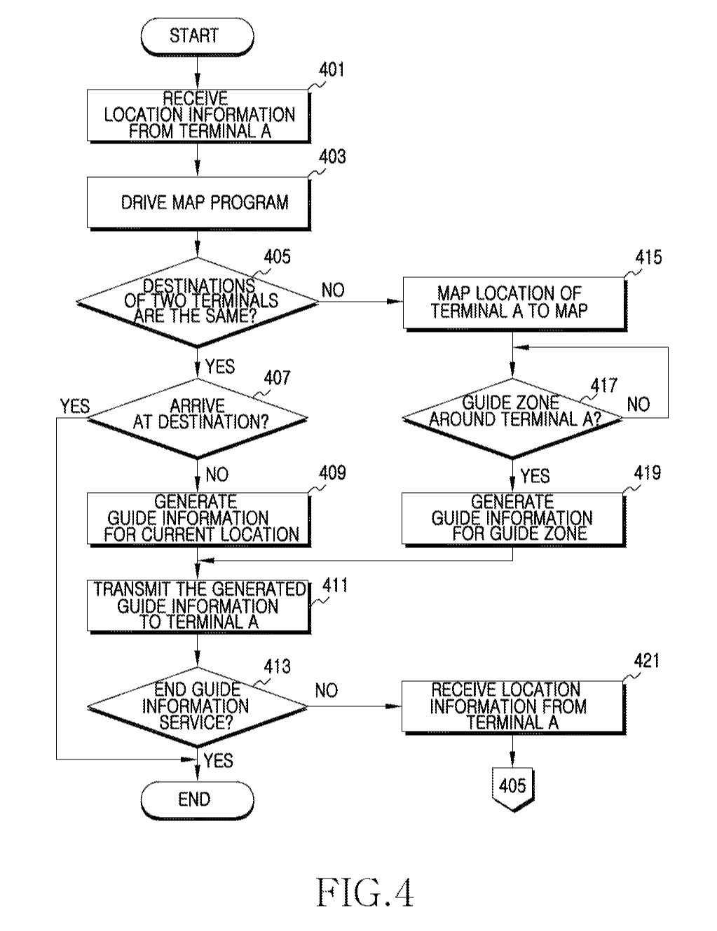

FIG. 4 is a flowchart for providing a navigation function in a portable terminal according to an exemplary embodiment of the present invention.

Referring to FIG. 4, after receiving the location information from terminal A in step 401, the portable terminal drives the map program in step 403. As a result, the portable terminal may receive information relating to a route (e.g., destination information) of terminal A from terminal A.

In step 405, the portable terminal determines whether its destination is the same as the destination of terminal A.

The destinations of the two terminals are examined in order to distinguish the type of guide information provided to terminal A. In more detail, if the destination of the portable terminal is the same destination as terminal A, the portable terminal can select the information of the route of terminal A to the destination as the guide information. When terminal A and the portable terminal are proceeding to different destinations, the portable terminal may select the information of a dangerous zone (e.g., a crossroad) as the guide information.

If it is determined that the portable terminal destination is the same destination as terminal A in step 405, the portable terminal examines whether terminal A arrives at the destination in step 407.

Upon determining that terminal A arrives at the destination in step 407, the portable terminal ends the process.

If it is determined that terminal A does not arrive at the destination in step 407, the portable terminal generates guide information for a current location of terminal A in step 409. More specifically, the portable terminal receives the location information in real time until terminal A arrives at the destination. In step 411, the portable terminal generates the guide information corresponding to the location of terminal A. In step 413, the portable terminal processes to transmit the guide information to terminal A. The portable terminal may generate the guide information for the current location of terminal A as text-type data.

By contrast, if it is determined that the destination of the portable terminal is different from the destination of terminal A in step 405, the portable terminal maps the location of terminal A to the map in step 415 and thus tracks the location of terminal A.

In step 417, the portable terminal determines a guide zone around terminal A. Herein, since the portable terminal does not proceed to the same destination as terminal A and cannot provide the guide information in real time, the portable terminal determines the guide zone to provide the guide information of a dangerous zone (e.g., a crossroad) around terminal A.

If it is determined that there is no guide zone around terminal A in step 417, the portable terminal repeats step 417 to determine the guide zone around terminal A.

If it is determined that there is a guide zone around terminal A in step 417, the portable terminal processes to generate the guide information for the determined guide zone in step 419. The portable terminal may generate the guide information for the corresponding zone as an image.

The portable terminal transmits the generated guide information to terminal A in step 411 and determines whether to end the guide information service in step 413.

If it is determined not to end the guide information service in step 413, the portable terminal receives the location information from terminal A in step 421 and then repeats step 405.

If it is determined to end the guide information service in step 413, the portable terminal ends the process.

As set forth above, according to the apparatus and the method for providing the navigation function, even when the portable terminal has no separate map data, the portable terminal having the map data determines and provides guide information relating to a current location of the terminal having no map data. Thus, road data can be received with no map data stored.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus of a portable terminal for providing road data to a first terminal including no map data, the apparatus comprising:
the first terminal including no map data for using a navigation function that uses a map of the portable terminal including the map data.

2. The apparatus of claim 1, further comprising:
a controller for receiving location information from the first terminal including no map data, for mapping a location of the first terminal to a map, for generating guide information for the location of the first terminal, and for transmitting the guide information to the first terminal.

3. The apparatus of claim 2, wherein the location information received from the first terminal including no map data comprises destination information of the first terminal including no map data.

4. The apparatus of claim 2, wherein, when destinations of the portable terminal and the first terminal are the same, the controller generates guide information in real time until the first terminal transmitting the location information arrives at the destination, and
when the destinations of the portable terminal and the first terminal are different, the controller generates information relating to a dangerous zone around the first terminal transmitting the location information, as the guide information.

5. The apparatus of claim 4, wherein the dangerous zone comprises a crossroad.

6. The apparatus of claim 4, wherein, when the destinations of the portable terminal and the first terminal are the same, the controller generates the guide information of a corresponding zone as an image, and
when the destinations of the portable terminal and the first terminal are different, the controller generates the guide information of a corresponding zone as a text.

7. The apparatus of claim 2, wherein, when the portable terminal and the first terminal are far away from each other, the controller connects the portable terminal and the first terminal using a wireless Internet network, and
when the portable terminal and the first terminal are close to each other, the controller connects the portable terminal and the first terminal using ad-hoc connection of a Wireless Local Area Network (WLAN).

8. The apparatus of claim 2, wherein the first terminal receives the guide information for the location of the first terminal and provides the navigation function using the received guide information.

9. The apparatus of claim 1, wherein the first terminal including no map data is a terminal capable of receiving a satellite signal necessary to locate the first terminal.

10. The apparatus of claim 1, wherein the portable terminal comprises a memory unit for storing the map data and a satellite signal receiver for receiving a satellite signal necessary to locate the portable terminal.

11. A method of a portable terminal for providing road data to a first terminal including no map data, the method comprising:
using, at the first terminal including no map data, a navigation function using a map of the portable terminal including the map data.

12. The method of claim 11, further comprising:
receiving location information from the first terminal including no map data;
mapping a location of the first terminal to a map using the received location information; and
generating and transmitting guide information for the location of the first terminal, to the first terminal.

13. The method of claim 12, wherein the location information received from the first terminal including no map data comprises destination information of the first terminal having no map data.

14. The method of claim 12, wherein the generating and transmitting of the guide information comprises:
determining destinations of the portable terminal and the first terminal;
when the destinations of the portable terminal and the first terminal are the same, generating guide information in real time until the first terminal transmitting the location information arrives at the destination; and
when the destinations of the portable terminal and the first terminal are different, generating information relating to a dangerous zone around the first terminal transmitting the location information as the guide information.

15. The method of claim 14, wherein the dangerous zone comprises a crossroad.

16. The method of claim 14, wherein, when the destinations of the portable terminal and the first terminal are the same, the guide information relating to a corresponding zone is generated as an image, and
when the destinations of the portable terminal and the first terminal are different, the guide information relating to a corresponding zone as a text.

17. The method of claim 12, wherein, when the portable terminal and the first terminal are far away from each other, the portable terminal and the first terminal having no map data are connected using a wireless Internet network, and
when the portable terminal and the first terminal are close to each other, the portable terminal and the first terminal having no map data are connected using an ad-hoc connection of a Wireless Local Area Network (WLAN).

18. The method of claim 12, wherein the first terminal receiving the guide information for the location of the first terminal, provides the navigation function using the received guide information.

19. The method of claim 11, wherein the first terminal having no map data is a terminal capable of receiving a satellite signal necessary to locate the first terminal.

20. The method of claim 11, wherein the portable terminal comprises a memory unit for storing the map data and a satellite signal receiver for receiving a satellite signal necessary to locate the portable terminal.
